(19) United States
(12) Patent Application Publication
(10) Pub. No.: US 2012/0052929 A1
(43) Pub. Date: Mar. 1, 2012

(54) INTERACTIVE PHONE CASE

(76) Inventors: KHAMVONG THAMMASOUK, San Jose, CA (US); KHANH M. LE, Morgan Hill, CA (US); JEFFREY LI, Palo Alto, CA (US); DAVID M. HOLMES, Cupertino, CA (US)

(21) Appl. No.: 12/872,656

(22) Filed: Aug. 31, 2010

(51) Int. Cl. H04M 1/00

(52) U.S. Cl. 455/575.1

(57) ABSTRACT

An interactive device has a plastic case for a mobile phone has graphics printed on the reverse side of a clear plastic film using non-conductive color inks. Electronic capacitive touch sensors are patterned and printed with conductive inks on a second plastic film in positions corresponding to individual graphic objects. A light guide layer is placed immediately beneath or above the pattern of printed electronic capacitive touch sensors. Diffusers on the top surface of the light guide layer catch light propagating and reflecting inside by refraction redirect it up to the user's eyes through openings in the non-conductive color ink graphics. The phone itself, a micro-controller, software, and associated electronic components mounted on a circuit board are used to control the lights sent into the light guide layer from its edges, and they control the response to touches being sensed by the touch sensors.

### BACKGROUND OF THE INVENTION

1. Field of the Invention

The present invention relates to electronic touch sensors associated with backlighting, and in particular to such integrated into the protective cases of mobile phones and other electronic devices.

2. Description of the Prior Art

Electronic, capacitive touch sensors are a highly effective input device in applications that cannot tolerate the bulk and expense of mechanical switches. Touch sensor pads can be printed or laminated on film and made very flat and thin, even on plastic films only a few tenths of millimeters thick.

Whole QWERTY keyboards for personal computers and even miniaturized ones for smart mobile phones can be implemented using thin film technologies and plastic sheets. Similarly, touch pads on laptop and netbook computers are popular applications of capacitive touch sensors on thin films. The toy industry and consumers alike are benefiting from the use of touch sensors on films in a new class of interactive toys. The toys can “wake up” and respond to a child when it is touched, and the sensors allow for different responses to the child's touch on one of the hands, feet, face, or belly, for example.

### SUMMARY OF THE INVENTION

Briefly, an interactive device embodiment of the present invention comprises a plastic case for a mobile phone, a large window in the case, and a clear plastic film is disposed in the window. Graphics and other designs are printed on the reverse side of the clear plastic film using non-conductive color inks. Electronic capacitive touch sensors are patterned and printed with conductive inks on a second plastic film in positions corresponding to individual graphic objects. A light guide layer is placed immediately beneath or above the pattern of printed electronic capacitive touch sensors, and a number of light diffusing patterns are etched on its top surface that will catch light propagating and reflecting inside the film and redirect it by refraction up to the user's eyes through openings in the non-conductive color ink graphics. The mobile phone itself, a micro-controller, software, and associated electronic components mounted on a circuit board are used to control the various LEDs that send lights through the light guide layer, and they control the response to touches being sensed by the respective capacitive touch sensors.

These and other objects and advantages of the present invention will no doubt become obvious to those of ordinary skill in the art after having read the following detailed description of the preferred embodiments that are illustrated in the various drawing figures.

### IN THE DRAWINGS

FIG. 1 is an exploded assembly view diagram of an embodiment of the present invention as an interactive case for a smart mobile phone;

FIG. 2 is a diagram showing how a conventional mobile phone can be upgraded with the interactive case of FIG. 1 and how application software can be downloaded for its use;

FIG. 3A is a cross sectional diagram of an embodiment of the present invention that can be used as a lighted touch sensor in the interactive case for a mobile phone shown in FIG. 1;

FIG. 3B is a detail taken from a portion of FIG. 3A and expanded to show the details and relationships of the elements surrounding each touch pad;

FIGS. 4A-4C are sectional diagrams of lighting and lighted touch sensor embodiment of the present invention;

FIG. 5 is a perspective view diagram showing how a flexible circuit implementation of a lighted touch sensor embodiment of the present invention can be fitted inside the case of a mobile device; and

FIG. 6 is a functional block diagram of an iPhone® application in an embodiment of the present invention.

### DETAILED DESCRIPTION OF THE PREFERRED EMBODIMENT

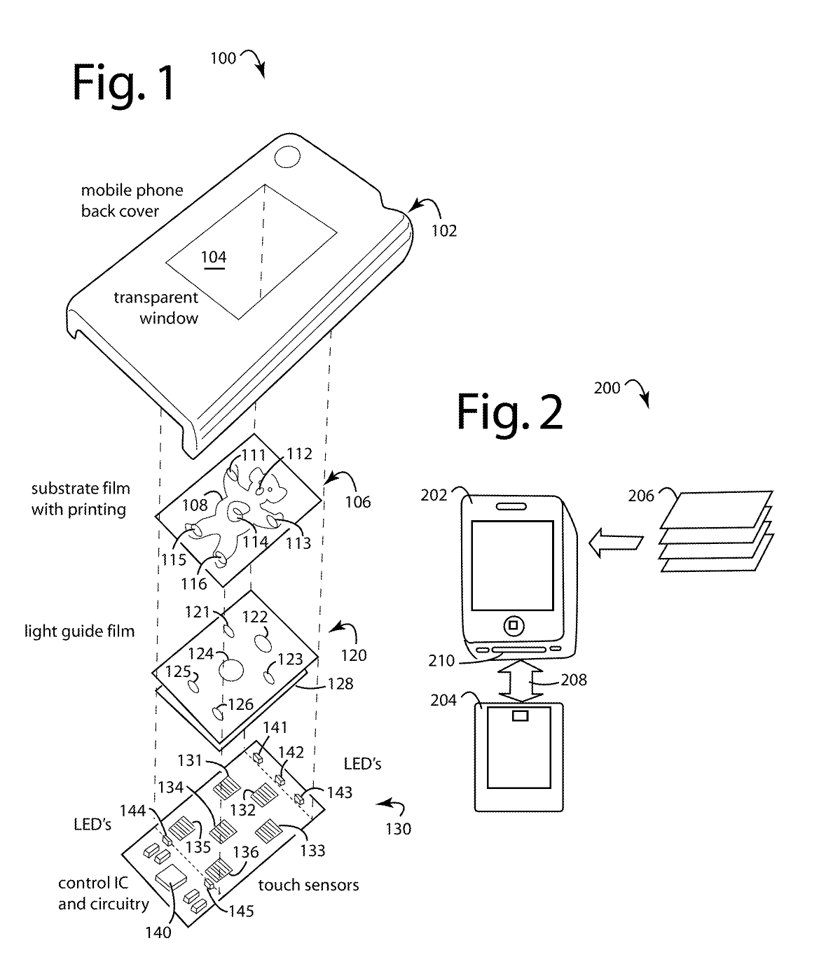

Embodiments of the present invention span the range of interactive appliances and consumer electronics device applications that are mass produced and depend on capacitive touch sensors and illuminated light guide films for user interaction. For example, in one particular application, FIG. 1 represents a mobile phone's interactive case as an embodiment of the present invention, and is referred to herein by the general reference numeral 100. The mobile phone interactive case 100 comprises a cover 102 configured to fit over the back cover of a popular mobile phone, e.g., an Apple iPhone, Motorola CLIQ, Blackberry Curve, etc. A transparent window 104 is disposed in the case and behind it are a stack of films and circuits that implement an interactive game.

For example, a plastic substrate film 106 of polyethylene terephthalate (PET) 0.025-1.0 millimeters thick has designs and reverse-image graphics of a bear 108 printed with non-conductive inks on a reverse side. Six windows 111-116 are provided in the ink printing that allow light to shine through in spots from beneath. These six spots correspond to the bear's right paw, face, left paw, tummy, right foot, and left foot.

One particular interactive game play involves touching each of these spots at the right times, according to instructions on the phone from the game being played, or to the blinking of lights under the control of a game embedded in the case's electronic memory. In another example, bear 108 is made to resemble an actual interactive plush toy that may already belong to the same user.

A light guide film 120 is adhered to the backside of the plastic substrate film 106. It accepts light produced at its respective edges. A set of six diffusers 121-126 correspond in placement to the six spots or small windows 111-116 in the ink printing above. These diffusers are essentially roughed areas created by a special process on the surface of an otherwise thick sheet of plastic film. Light coming in from the edges of the light guide film 120 will propagate throughout inside the plastic film. The light will bounce between the top and bottom surfaces of the film and some will be partially reflected back and some will refracted to escape the surfaces depending on the incident angles of the internal reflections. The light that reaches the top and bottom surfaces at angles below a critical angle will escape. Such critical angle is defined by the indices of refraction of the light guide film material, and the nature of the layers that are immediately above and below.

According to Wikipedia: When the light or other wave involved is monochromatic, that is, of a single frequency, Snell's law can be expressed in terms of a ratio of wavelengths in the two media, λ1 and λ2:

$$\frac{sin {θ}_{1}}{sin {θ}_{2}} = \frac{{υ}_{1}}{{υ}_{2}} = \frac{{λ}_{1}}{{λ}_{2}} .$$

When light travels from a medium with a higher refractive index to one with a lower refractive index, Snell's law seems to require in some cases (whenever the angle of incidence is large enough) that the sine of the angle of refraction be greater than one. This of course is impossible, and the light in such cases is completely reflected by the boundary, a phenomenon known as total internal reflection. The largest possible angle of incidence which still results in a refracted ray is called the critical angle. In this case, the refracted rays travel along the boundary between the two media.

In the case of light guide film 120, such refracted light will escape the light guide film surface and become visible to a user looking down on the surface of the light guide film 120. Diffusers made of surface interface disturbances can catch light propagating and reflecting inside the light guide film and allow it escape upward by refraction. There are many ways that spots on the surfaces of the light guide layers can be prepared for light diffusion.

Here, two basic ways are described for fabricating the diffusers, (1) by depositing dense bunches of colored ink bubbles onto the surface of light guide film, or (2) by etching tight groups of small spherical voids into the light guide film. The surface could also be roughened, e.g., by molding, sanding, or scratching. The resulting diffusers will catch light from inside the light guide film and appear to illuminate, while areas without such features at the surface appear dark.

Here six clusters of diffusing bubbles are positioned on the light guide film 120 that correspond to the bear's right paw, face, left paw, tummy, right foot, and left foot. They can thus be made to “light up” by shining light from LED's into the light guide film. A reflective film 128 is placed behind the light guide film 120 to improve brightness by reflecting back into the light guide film some of the light leaks out through the bottom surface.

A circuit board 130 has printed or laminated conductive-ink patterns for six capacitive touch sensors 131-136. These correspond in their respective placements to the six diffusers 121-126 and the six openings or windows 111-116 in the film stacks above. The light guide film 120 and plastic substrate film 106 nest at their edges in between LED's 141-145. These provide edge lighting to operate light guide film 120 and to respectively illuminate the six diffusers 121-126. A control integrated circuit (IC) 140 with internal memory, associated touch sensor circuitry and control software complete the interactive game implementation.

FIG. 2 represents a combination device 200 that includes a conventional phone 202 with an interactive case 204 plugged into the phone 202. A number of application programs 206 are downloadable to the phone 202 that support games and other functions provided by the interactive case 204. A connection 208 is made between the interactive case 204 and a standard connector 210 usual to widely marketed phones 202. For example, standard connector 210 includes Apple iPhone/iPod dock connectors, micro-USB connectors, etc. Connections between the interactive case and the phone best comprise Wi-Fi, Bluetooth, wireless USB, and other industry-standard specifications.

In general, embodiments of the present invention include a transparent plastic film printed with decorative color graphics in non-conductive inks, a second transparent plastic surface with conductive traces for touch sensors, a light-guide film, a plastic case, a means to electronically communicate between the case and a mobile device, and any corresponding applications software.

The overall thickness of the plastic film combinations ranges from 0.025-mm to over 1.0-mm, depending on the application. Compatible printing methods for the graphics variously include cyan-magenta-yellow-black color model (CMYK), inkjet, silkscreen, transfer, offset, etc. The touch sensors can be printed with silver ink, or they can be patterned with indium tin oxide (ITO) on a flexible plastic substrate. The touch sensors can also be patterns etched from copper laminated on conventional substrates. The electronic control circuits, LED's, and other circuit components are also mounted on these same substrates. In alternative embodiments, a enough lighted touch sensors can be included in a large area plastic surface to a build a complete pull-out QWERTY keyboard, or a high precision touch pad, like those in common use today in notebook computers.

The decorative graphics with embedded touch sensors, selective lighting, and application software, can be used in a wide variety of applications, such as interactive touch-enabled cases for consumer electronics devices, computer touch pads, industrial control buttons, keypads, toys, computer mice, cell phones, tablet computers, personal media players, mobile phones, game consoles, et cetera, and with downloadable software update/upgrade capabilities.

Embodiments of the present invention enable a novel category of interactive devices such as portable media players, phone cases, phone-based game controllers, appliance controllers, et cetera, with integrated graphics, touch sensitive functions, and selective lighting, all with low-cost mass producible materials and processes. These versatile hardware-software platforms can accept inputs from a user or device, and output instructions or report the functional status back using the decorative patterned display. Updates and upgrades of the personality or functionality are easily implemented with downloadable software.

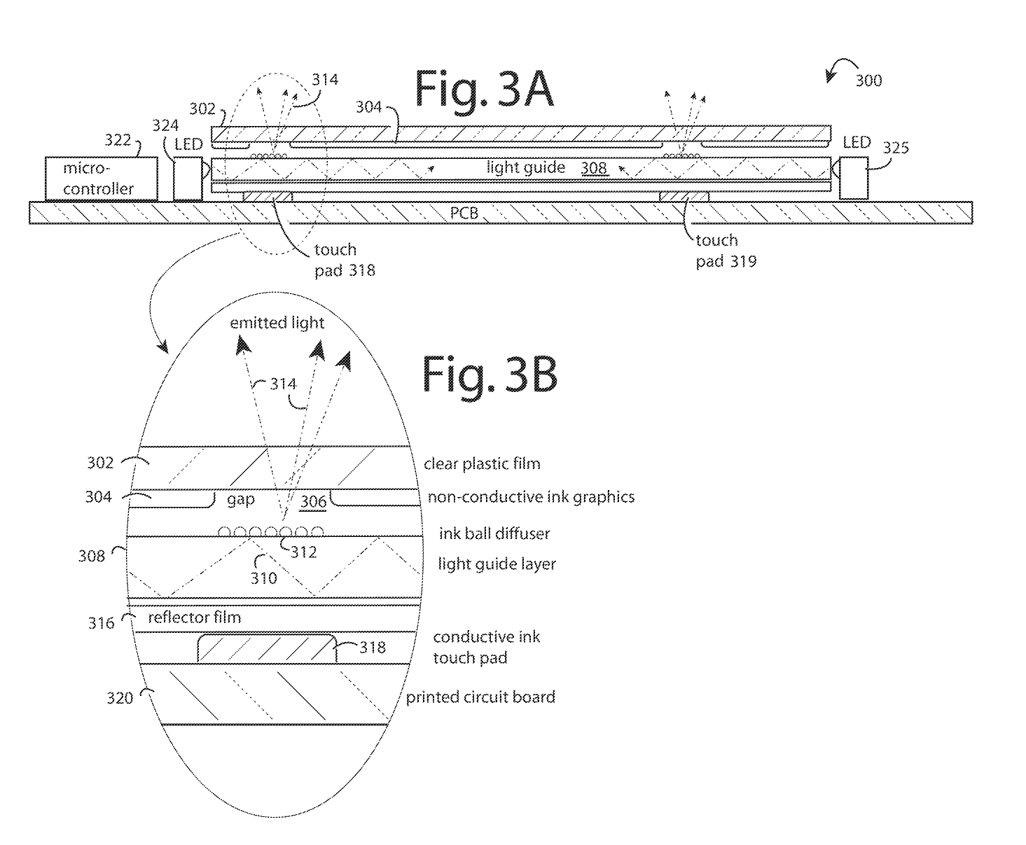

FIGS. 3A and 3B represent an interactive device 300 that has touch sensor inputs and light displays behind printed graphics for output. Substantially nothing more than a bare clear plastic film 302 on a top side is ultimately exposed to the environment and user wear. The clear plastic film 302 can comprise transparent, thin, flexible or rigid polyethylene terephthalate (PET), polycarbonate (PC), poly methyl methacrylate (PMMA), clear acrylonitrile butadiene styrene (ABS), or similar plastics. The clear plastic film 302 is pre-treated with heat to reduce subsequent long-term shrinkage. Non-conductive four-color CMYK inks are used for reverse-image graphics 304. The materials used in the graphics and designs are such that any printed electronic capacitive touch sensors located immediately below will not be electrically short-circuited nor desensitized by their mutual contact or proximity.

A number of gaps 306 are left in the reverse-image graphics 304 so light from below can pass through to the user easily. A light guide layer 308 is illuminated at its edges with a light 310 that bounces along inside because of its high angle of incidence with the top and bottom surfaces. However, a surface roughening or diffusion 312 will catch light striking at higher than a “critical angle”. This causes an emitted light 314 to appear to a user through gap 306. A reflector film 316 is set on the opposite side beneath the light guide layer 308, and this reflects back any light escaping out the bottom and thus improve the brightness of the emitted light 314.

A touch pad 318 is aligned below with the corresponding diffusion 312 and gap 306. Touch pad 318, and others like touch pad 319 are printed on a printed circuit board (PCB) using silvered or otherwise conductive inks, etched copper patterns laminated on the circuit board, or deposited indium tin oxide (ITO). A micro-controller 322 performs overall system control, stores program and data, has outputs connected to control light emitting diodes (LED's) 324 and 325, and capacitive sensor inputs for touch pads 318 and 319. For example, the microcontroller may convert a touch pad input from a user into a light output response that comes from the corresponding light guide diffusion above the touch pad.

Adhesives can be used to permanently join the various layers of interactive device 300 together. In some applications requiring greater touch sensitivity, the conductive-ink touch pads can be placed above the light guide on their own substrate film. These touch pads are made from deposited and patterned indium tin oxide (ITO). ITO is near transparent and will not significantly dampen the intensity of emitted light 314 that has to pass through.

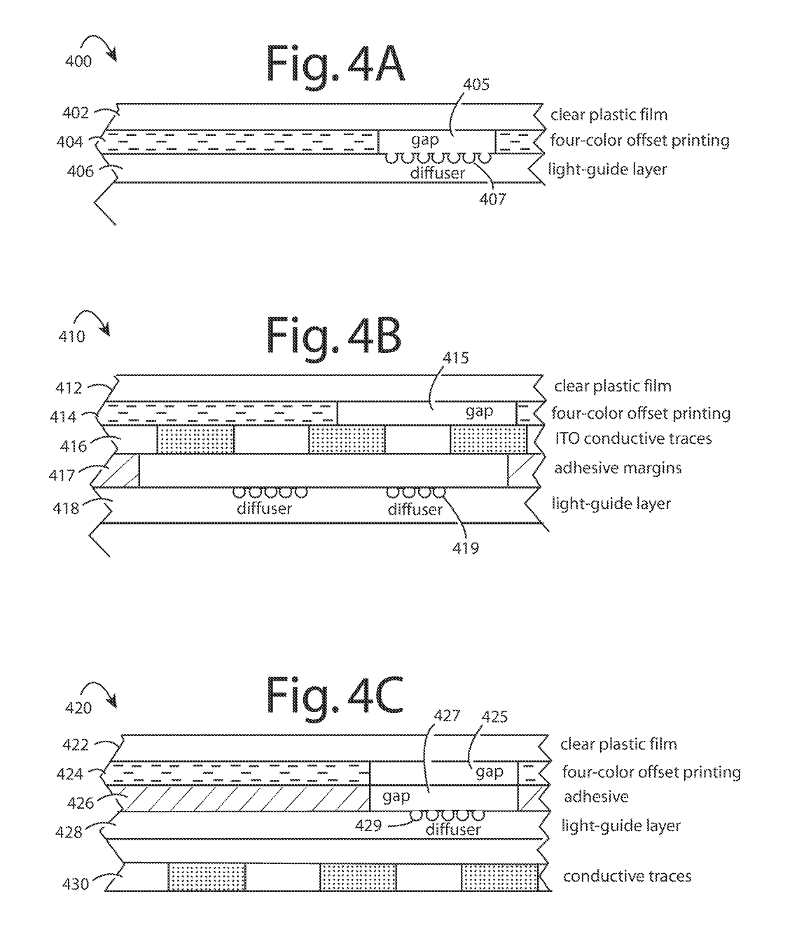

FIGS. 4A-4C represent three alternative embodiments for lighting and lighted touch sensors. In FIG. 4A, a first, basic touch sensor lighting 400 comprises a top, clear plastic film 402 which has an underside offset printed with non-conductive four-color ink 404. At least one gap 405 in the printing allows light to pass through from a light guide layer 406 beneath. Such is like that shown in FIGS. 3A-3B, but a diffuser 407 comprises tight groups of very small spherical voids that have been etched into the top surface of the light guide layer 406.

In FIG. 4B, a second Variation is a decorative lighted touch sensor 410 which comprises a top, clear plastic film 412 which has an underside offset printed with four-color ink 414. At least one gap 415 in the printing allows light to pass through from beneath. Conductive traces 416 of transparent, indium tin oxide (ITO) patterned for touch sensor pads and their interconnects are deposited directly on the bottom surface of the four-color ink 414. A liquid adhesive 417 is silkscreened on around the outside margins to join the upper layers to a light guide layer 418 beneath without clogging up or interfering with any light diffusers like a diffuser 419. Here, diffuser 419 comprises tight groups of very small spherical voids that have been etched into the top surface of the light guide layer 418. Such light guide layer 418 is also like those in FIGS. 3A-3B.

The lighted touch sensor 410 variation offers good touch sensitivity because the conductive traces 416 for the touch sensor pads are relatively close to the top surface.

In FIG. 4C, a third variation is a lighted touch sensor 420 which has a top, clear plastic film 422 with an underside that has been offset printed with a four-color ink 424. A gap 425 in the ink allows light to pass up from below. A liquid adhesive 426 with a gap 427 is silkscreened or otherwise applied to join the top layer to a light guide layer 428 beneath. A diffuser 429 is etched into the top surface of the light guide layer 428. To avoid a reduction in the intensity of the light passing through the adhesive layer 426, and further to prevent the adhesive from filling the diffuser 429, such adhesive is only applied to the areas safely away and at the edges of the light guide film. Light guide layer 428 is also like those in FIGS. 3A-3B. Conductive traces 430 of silvered inks are patterned for touch sensor pads and their interconnects are deposited directly on the back surface of the light guide layer 428.

Adhesives 418 and 426 can comprise silk-screen applied liquid water-based adhesives. The particular adhesives used need to be applied precisely, selectively, uniformly, and safely away from the diffusion sites and at the edges of the film, so screen printing is a very good method to use. Of course, other kinds of adhesives can be applied.

A final overcoat of adhesive is applied to the bare backside of the plastic film combination to protect against scratches and the environment.

Although an interactive case for a mobile phone has been illustrated as an exemplary embodiment, other embodiments are also cost effective and attractive. For example, a keyboard, or a touch pad similar to those used for a laptop portable computer, or even a game console can be implemented with embodiments of the present invention.

An entire assembly of printed plastic, light guide films and sensors may be connected to electronic circuitry mounted either on the same plastic film or on a separate flexible printed circuit (FPC) or a rigid printed circuit board (PCB) or other means attached with an anisotropic conductive film (ACF) or conductive pressure-sensitive adhesive (PSA) bond. Such can then be fastened to a toy, a door, a backpack, clothing, and another surface with an appropriate adhesive. These devices are useful in products that employ touch sensing through plastic, and add new dimensions which colorful, sharp, and durable graphics and selective illumination light guide films are made possible.

Combinations of the various building blocks described here can be used to make lighted and decorative capacitive touch sensors. Opaque masks can be included to obscure any view of the sensor layer, underlying structures, lighting, etc. from leaking through to the user. However, if the graphics used are dense enough, that alone could be relied on to hide the sensors. In some cases, it may be acceptable if the sensors and other devices visually show through, in which case the add-on opaque layers can be omitted.

Single-layer solutions are fully integrated devices. In one type, the color graphics, an opaque mask, printed silver ink touch sensors, and adhesive application are all disposed on a back side of a single PET layer, for example. In a second type of single layer solution, the color graphics and a top coating or laminated thin clear PET film are disposed on the front side of a heavier PET layer. An opaque mask, printed silver ink touch sensors, and adhesive application are disposed on a back side, for example.

Two-layer solutions, such in FIGS. 4B and 4C, assemble a graphics lamination in front of a sensor lamination. In a first type of graphics lamination, the color graphics, opaque mask, and adhesive application are all disposed on a back side of a PET substrate, for example. In a second type of graphics lamination, the color graphics and a top coating or laminated thin clear PET film are disposed on the front side of a heavier PET layer. An opaque mask and adhesive are applied to the back side. If the graphics lamination includes an opaque layer or PET substrate, then the sensor lamination need not include it.

Three-layer solutions include the two-layer solution and a second layer of conductive ink patterns immediately adjacent to the first layer of conductive ink patterns. But, these must be isolated by an intervening non-conductive layer. A dense, two-dimensional sensor array is made possible for precision touch pad applications.

Multi-layer sensor solutions can include one, two, and three-layer solutions with additional sensor layers, light guide films and opaque light blocking layers to form even more selective lighting patterns.

Double-sided graphic solutions can be realized by starting with a one, two, or three-layer solution, and then attaching another graphic lamination on the back side such that the graphic faces reverse. Single layer devices can be deployed on both the front and/or back sides of an application that requires equal qualities and responses on each side.

Double-sided graphics with complex arrays of sensors can be constructed using the above multi-layer sensor solutions with a graphic laminated to the back like in the double-sided graphic solution. The second sensor layer can comprise touch sensors deposited on top of a PET layer, with an opaque mask and adhesive applied underneath.

Embodiments of the present invention employ alternative kinds of electrical connections for the capacitive touch sensors. Low temperature methods are required because excessive heat like used, e.g., in soldering will deform the PET film materials supporting the silver-ink features.

The successful printing of conductive, silver-ink circuits and patterns on top of PET with four-color graphics and opaque masks requires thicker and more viscous inks than customary to bridge the gaps and prevent breaks that would otherwise occur during curing. The thickness of the lines used in experiments was one millimeter pitch minimum, meaning at least one millimeter between lines and 0.5-1 mm silver ink traces. The viscosity of the ink was not high, but it was higher than normal silver ink. The thickness was controlled by mixing different components together and was not quantified. The plastic was a high temperature grade PET good up to 140-degrees Celsius.

A thinner silver-ink PET layer can be used in order to minimize the cost of that layer. Single layer construction eliminates an extra PET layer and adhesive layer that can be costly and increase lower labor costs. Using screen printable adhesives can reduce the amount of wasted material and labor. Die-cutting machines can be use to produce both alignment holes and features, thus increasing accuracy and reducing the number of production steps.

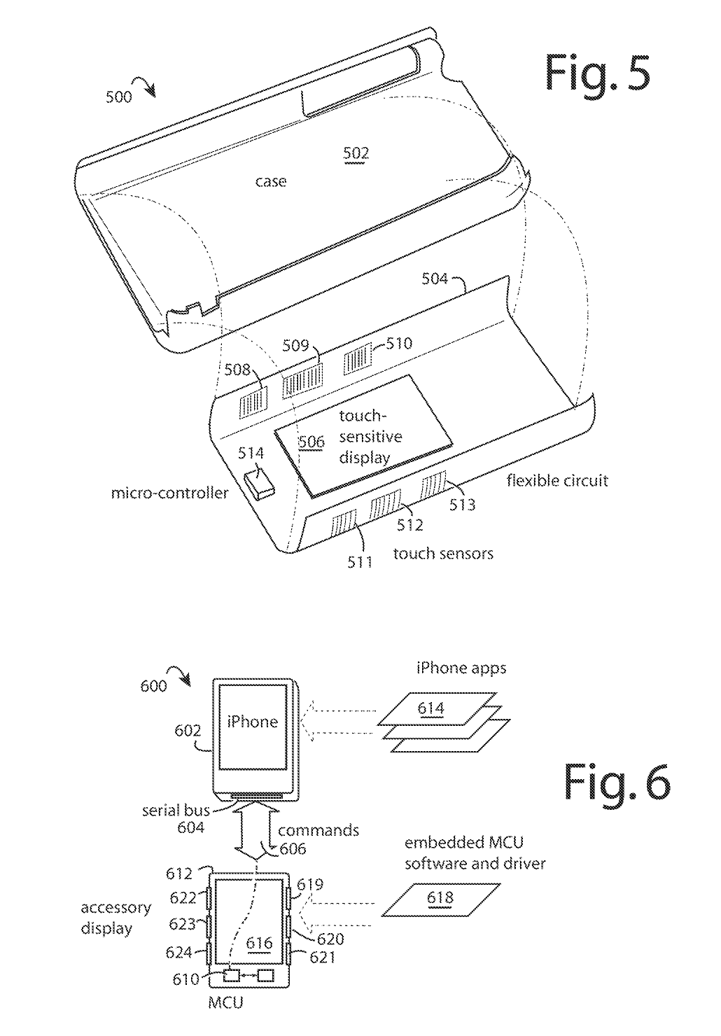

FIG. 5 shows how a flexible circuit implementation of a lighted touch sensor embodiment of the present invention can be fitted inside the case of a mobile device. A mobile device add-on 500 comprises a back-side case 502 into which is fitted a flexible circuit 504. A touch sensitive display 506 and touch sensors 508-513 are controlled by a micro-controller 514. For example, the embodiments of FIGS. 1, 2, 3A, 3B, and 4A-4C can be adapted for this kind of application. A front side piece of the case can be designed with lighted touch sensors and/or decorative graphics on the front surface of the case where space allows.

FIG. 6 represents a smart case application 600 for an Apple® iPhone® 602. The case connects with the iPhone through the serial bus pins 604 available from the Apple 30-pin connector and follows the standardized hardware interface, protocols, and commands 606 proprietary to Apple Inc. (Cupertino, Calif.). Provision is made so that the smart case 612 can communicate with the iPhone 602 and run under the control of iPhone apps 614 built on the iPhone operating system (iOS). The smart case 612 further includes an accessory illuminated touch sensitive display 616, an embedded MCU software and driver 618, and touch sensors 619-624 that can be programmed to perform various interactive control functions. For example, such control buttons can be used for a gaming application hosted on the iPhone 602.

Various kinds of interactive appliances have been described here in terms of specific applications like cases and back covers for mobile phones, or an iPhone in particular. Such was presented this way to demonstrate the range of applications and usefulness of such appliances. Such interactive appliances can further include their own batteries to provide for their power consumption alone, and/or to extend the battery life of the mobile devices they attach to.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. An interactive appliance, comprising:
a cover configured to fit onto a mobile device;
a transparent window made of a clear first plastic film having a reverse side for reverse-image graphics and designs, and a front side for exposure to the environment and user wear, and disposed in interactive case;
a printing of non-conductive color inks including said graphics and designs and disposed on said reverse side of the transparent window such that any printed sensors located immediately behind are not electrically short-circuited nor desensitized by their mutual contact or proximity;
a plurality of windows in the printing for passing through light from beneath for viewing by a user;
a plurality of electronic capacitive touch sensors comprising conductive inks and positioned behind the non-conductive color inks in lateral positions corresponding to respective ones of the windows;
a light guide layer disposed immediately beneath or above the pattern of printed electronic capacitive touch sensors; and
a plurality of diffusers on or in a surface of the light guide layer, and in lateral positions corresponding to respective ones of the windows and individual electronic capacitive touch sensors;
wherein, an interactive touch sensor display provides additional functionality to the mobile device.

2. The interactive appliance of claim 1, further comprising:
a number of light emitting diodes (LED's) positioned around the perimeter edges of the light guide layer and providing a source of light to respective ones of the plurality of diffusers; and
a micro-controller unit (MCU) connected to drive the LED's and to sense user touches coming in proximity to the plurality of printed electronic capacitive touch sensors, and thereby provide an interactive functionality.

3. The interactive appliance of claim 2, further comprising:
a mechanism for downloading application software to the MCU to provide a variety of interactive functionalities; and
a micro-controller unit (MCU) connected to said mobile device and able to execute said application software after downloading.

4. The interactive appliance of claim 2, wherein the plurality of diffusers each comprise:
a tight group of spherical voids etched into the top surface of the light guide layer.

5. The interactive appliance of claim 2, wherein the plurality of diffusers each comprise:
a dense bunch of colored ink bubbles on the top surface of the light guide layer.

6. An interactive appliance for a mobile phone, comprising:
a back cover configured to fit onto a mobile phone;
a transparent window made of a clear first plastic film having a reverse side for reverse-image graphics and designs, and a front side for exposure to the environment and user wear, and disposed in interactive case;
a printing of non-conductive color inks including said graphics and designs and disposed on said reverse side of the transparent window such that any touch sensors located immediately behind are not electrically short-circuited nor desensitized by their mutual contact or proximity;
a plurality of windows in the printing for passing through light from beneath for viewing by a user;
a plurality of electronic capacitive touch sensors comprising conductive inks and positioned in association with the non-conductive color inks in lateral positions corresponding to respective ones of the windows;
a light guide layer disposed immediately beneath or above the pattern of printed electronic capacitive touch sensors;
a number of diffusions in a surface of the light guide layer in lateral positions corresponding to respective ones of the windows and individual electronic capacitive touch sensors;
a number of light emitting diodes (LED's) positioned around the perimeter edges of the light guide layer and providing a source of light to respective ones of the number of diffusions;
a micro-controller unit (MCU) connected to drive the LED's and to sense user touches coming in proximity to the pattern of printed electronic capacitive touch sensors, and thereby provide an interactive functionality;
a mechanism for downloading application software to the MCU to provide a variety of interactive functionalities; and
an authentication chip connected to the MCU to enable access to proprietary hardware interfaces, protocols, and commands;
wherein, an interactive touch sensor display provides additional functionality to the mobile phone.

7. A touch sensor display, comprising:
a transparent window made of a clear first plastic film having a reverse side for reverse-image graphics and designs, and a front side for exposure to the environment and user wear;
a printing of non-conductive color inks including said graphics and designs and disposed on said reverse side of the transparent window such that any printed sensors located immediately behind are not electrically short-circuited nor desensitized by their mutual contact or proximity;
a plurality of windows in the printing for passing through light from beneath;
a plurality of printed electronic capacitive touch sensors comprising conductive inks and positioned in association with the non-conductive color inks in lateral positions corresponding to respective ones of the windows;
a light guide layer disposed immediately beneath or above the pattern of printed electronic capacitive touch sensors; and
a number of diffusers on a surface of the light guide layer, and in lateral positions corresponding to respective ones of the windows and individual electronic capacitive touch sensors.

8. The touch sensor display of claim 7, further comprising:
a number of light emitting diodes (LED's) positioned around the perimeter edges of the light guide layer and providing a source of light to respective ones of the number of diffusions.

9. The touch sensor display of claim 7, further comprising:
a micro-controller unit (MCU) connected to drive the LED's and to sense user touches coming in proximity to the pattern of printed electronic capacitive touch sensors, and thereby provide an interactive functionality.

10. The touch sensor display of claim 7, further comprising:
a reflective layer positioned beneath the light guide layer and providing for increased light emitted by the number of diffusions.
